(19) United States
(12) Patent Application Publication
(10) Pub. No.: US 2008/0102243 A1
(43) Pub. Date: May 1, 2008

(54) Laminate fire retardant systems and uses

(76) Inventor: Laxmi C. Gupta, Los Alamitos, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/973,908

(22) Filed: Oct. 11, 2007

Related U.S. Application Data
(60) Provisional application No. 60/851,025, filed on Oct. 11, 2006.

(51) Int. Cl. B32B 27/00; B05D 1/00; B32B 33/00; B32B 7/02; B32B 9/04

(52) U.S. Cl. 428/41.8; 427/186; 428/213; 428/411.1; 428/500

(57) ABSTRACT

Fire retardant roofing membranes and laminates are provided, wherein the laminates have an outer layer of a cured polymeric film comprising a non-halogenated fire retardant component, the fire retardant component being from greater than about 55% to about 95% of the outer layer by weight. Methods of protecting a substrate from fire damage are also described using two and three layer laminates.

### PRIORITY CLAIM

This application claims priority to U.S. Provisional application No. 60/851,025, entitled LAMINATE FIRE RETARDANT SYSTEMS AND USES, filed on Oct. 11, 2006 which is herein incorporated by reference in its entirety.

### FIELD OF INVENTION

The present invention relates to fire retardant systems and related methods and uses of such fire retardant systems.

### BACKGROUND OF THE INVENTION

Fire retardants are well-known and are typically added to and/or applied as a surface treatment to help prevent the spread of fire and/or protect a material exposed to fire. Commercially available fire retardants may be obtained in great variety, including examples such as bromine-based fire retardants, phosphorous-based fire retardants (e.g., ammonium polyphosphate (APP)), nitrogen-based fire retardants (e.g., melamine), inorganic-based fire retardants, and chlorine-based fire retardants.

A fire retardant can also be classified by the mechanism in which it acts as a fire retardant. A well-known flame retarding mechanism is known as “intumescence,” and is attributable to the fire retardant category known as “intumescents.” Intumescent fire retardants expand and form a char layer as a barrier between the underlying material and surrounding environment. This char layer is hard to burn, and insulates and protects the underlining material from burning. Intumescents operate by expansion either as a result of a chemical reaction under heat, or as by a primarily physical reaction that occurs due to the configuration of components in the intumescent material. Examples of chemical intumescents include phosphate-based materials and silica gel/potassium carbonate mixtures. Examples of physical intumescents include expandable graphite.

Fire retardants can be used with a wide variety of items such as furniture, floors (e.g., floor coverings), decks (e.g., deck coverings), textiles, cables, building materials and insulation, electrical equipment, structures like pipe racks, equipment foundation, supporting structures, columns, beams, transportation equipment (e.g., truck-bed liners), roofs (e.g., roof coating), and the like. For example, fire retardant compositions have been disclosed for use as a layer on the underside of fabrics, with optionally high fire retardant content in U.S. Pat. No. 6,265,082. By applying the fire retardant cured film to the back side of a flexible substrate as a dry film, the resulting laminate maintains the desired properties such as surface texture, hand, drape and the like. See column 3, line 59 to column 4, line 14 and column 2, lines 50-53.

It would be desirable to provide plastic constructions with effective flame retardancy, but often such use is not a reality because of technical hurdles involved in incorporating fire retardants such constructions without adversely affecting the performance properties and/or the cost of the construction.

There is a continuing need for new and improved fire retardant systems that can provide superior fire protection to plastic constructions and structures. Additionally, there is in particular a need to provide roofing membranes that provide an enhanced degree of fire retarding function as compared to conventional constructions.

### SUMMARY OF THE INVENTION

The present invention provides in a first embodiment a roofing membrane that is a laminate comprising an outer layer of a cured polymeric film comprising a non-halogenated fire retardant component, the fire retardant component being from greater than about 55% to about 95% of the outer layer by weight and a polymeric film underlayer.

In another embodiment of the present invention, a method for protecting a roof surface substrate from fire damage is provided that comprises providing the roofing membrane as described herein, and applying the roofing membrane to a roof surface substrate with the polymeric film underlayer being in contact with the roof surface substrate. This orientation of the roofing membrane on the roof structure provides enhanced protection of the roof from floating embers or the like that could cause a fire originating from outside of the building.

In another embodiment of the present invention, a method for protecting a substrate from fire damage is provided, comprising first a) providing a fire retardant laminate, comprising: i) an outer layer of a cured polymeric film comprising a non-halogenated fire retardant component, the fire retardant component being from greater than about 55% to about 95% of the outer layer by weight; and ii) an organic support layer to which the outer layer is laminated. This laminate is applied to a substrate with the organic support layer being in contact with the substrate. This orientation of the laminate on the substrate provides enhanced protection of the substrate from external fire sources, such as embers or the like, that could initiate a fire on the substrate. In particular, the configuration of this laminate provides a unique system that can afford surprising protection against fire without interfering with the function of the laminate in its ultimate use. Thus, a polymeric support layer that can be used as a waterproofing structure, a structural support, an insulation layer, and the like, is provided with fire retardant properties without the primary functionality of the support being compromised by high loading of fire retardant material. Because the fire retardant is concentrated in the outer layer, the fire retardancy effect is maximized with a minimal amount of fire retardant component being required for incorporation in the product as a whole. Additionally, a high degree of protection from fire is afforded while not compromising the desired physical properties of the laminate as a whole, because a substantial portion of the laminate (i.e. the support layer) can be formulated without the need to incorporate fire retardant at all.

In one embodiment of the present invention, the organic support layer is a polymeric material that forms a polymeric support layer. In an embodiment of this embodiment of the present invention, the polymer portion of the outer layer is the same as the polymeric material of the support layer. By utilizing the configuration of the present invention, the outer layer is supported by the polymeric support layer which provides the desired physical properties, and the outer layer affords better fire retardant properties than could be obtained by a like product wherein the fire retardant is dispersed throughout the polymeric support layer rather than concentrated in an outer layer as presently provided.

In another embodiment of the present invention, a fire retardant laminate is provided for application to a substrate, comprising a) a polymeric film having a first and a second major surface, the film comprising a non-halogenated fire retardant component, the fire retardant component being from greater than 55% to about 95% of the polymeric film by weight; b) a layer of pressure sensitive adhesive coated on the first major surface of the polymeric film; and c) a release liner removably adhered to the layer of pressure sensitive adhesive. This construction provides a highly fire resistant layer that is ready for convenient lamination to any desired substrate. By providing a fire retardant containing film with a pressure sensitive adhesive that is protected by a release liner, this construction can be readily delivered to any desired site of application, whether that be in a remote factory or on a work-site such as a for application on a roof or wall of an existing structure. In use, the construction is preferably delivered to the location of application and the release liner is removed so that the pressure sensitive adhesive is exposed. The fire retardant containing film is adhered to the desired location using the pressure sensitive adhesive.

In another embodiment of the present invention, a fire retardant laminate is provided having at least three layers. The layers comprise a) a first outer layer of a polymeric film comprising a non-halogenated fire retardant component, the fire retardant component being from greater than about 55% to about 95% of the outer layer by weight; b) an intermediate organic support layer; and c) a second outer layer of a polymeric film comprising a non-halogenated fire retardant component, the fire retardant component being from greater than about 55% to about 95% of the outer layer by weight. Thus, one or more intermediate layers are “sandwiched” between outer fire protective layers. This construction is believed to provide superior fire protective properties by inhibiting the initiation of fire from external sources, and also helping to inhibit promulgation of fire in the event that a substrate to which the laminate is applied itself has caught fire.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is an edge view of a fire retardant laminate of the present invention.

FIG. 2 is an edge view of an adhesive coated fire retardant layer of the present invention.

FIG. 3 is an edge view of an adhesive coated fire retardant layer of the present invention, additionally provided with a release liner.

FIG. 4 is an edge view of a three layer fire retardant laminate of the present invention.

FIG. 5 is a graph showing the curing characteristic for a film of the present invention.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

Turning now to the drawing for further illustration, wherein like numerals indicate like parts, FIG. 1 is a fire retardant laminate 10 of the present invention, wherein an outer layer 12 comprises a cured polymeric film comprising a non-halogenated fire retardant component 14 dispersed therein. Preferably, the non-halogenated fire retardant component 14 is homogeneously dispersed in the outer layer 12. The fire retardant component 14 is present in an amount from greater than about 55% to about 95% of the outer layer by weight. More preferably, the fire retardant component being from about 60% to about 90% of the outer layer by weight.

In an embodiment of the present invention, the outer layer of cured polymeric film has a thickness of from about 0.5 mils to about 120 mils, and more preferably from about 10 mils to about 30 mils.

The outer layer of a cured polymeric film may comprise as its polymeric component any material that will support a dispersion of fire retardant material therein. In an embodiment of the present invention, the cured polymeric film comprises a polymer selected from the group consisting of ethylene polypropylene rubber, ethylene propylene diene monomer polymers, thermoplastic polyolefin, epoxy, polyurethane, polyurea, polyester, and copolymers and blends thereof. In another embodiment the cured polymeric film comprises a polymer selected from the group consisting of ethylene polypropylene rubber, ethylene propylene diene monomer polymers, and copolymers and blends thereof.

The fire retardant component 14 is any appropriate non-halogenated ingredient such as is known in the art to suppress flame. Typical fire retardant components can be classified as either halogenated or non-halogenated. Halogenated fire retardants contain a mixture of primary, secondary or tertiary halogen, which can dehydrohalogenate over a wide range of temperatures. Examples of halogen containing fire retardants include chlorinated paraffins, and brominated biphenyls such as tetrabromobisphenol A and decabromodiphenyl oxide. Non-halogenated fire retardant components are mainly metallic oxides or hydroxides that contain water of hydration. Examples of these include aluminum trihydride (ATH) and magnesium hydroxide, both of which provide fire retardancy from their inherent water content. Antimony trioxide and zinc borate are also used as fire retardant additives in view of their fire retardancy. Antimony trioxide is often used in combination with halogenated fire retardant additives such as tetrabromobisphenol A.

Another family of fire retardants is the phosphorus containing compounds, such as tris(2,3-dibromopropyl)phosphate and other phosphate esters. Antimony trioxide is often used in combination with phosphate esters. Additional fire retardant components include nitrogen-based fire retardants, such as melamine. A preferred melamine coated, APP fire retardant component for use in the present invention is commercially available from JLS Fire retardants Chemical Inc., Pomona, Calif., under the tradename JLS-APP101. This melamine coating has intumescent properties which enhances the flame retardancy properties of the fire retardant system of the invention.

Preferably, the flame-retardant ingredient is phosphate-based. Preferred phosphate-based fire retardant components include polyphosphates, preferably ammonium polyphosphate (APP). APP and methods of making APP are well known as described in, e.g., U.S. Pat. No. 5,165,904 (Staffel et al.), U.S. Pat. No. 5,277,887 (Staffel et al.), and U.S. Pat. No. 5,213,783 (Fukumura et al.), the disclosures of which are incorporated herein by reference. An embodiment of a fire retardant system contemplated herein includes a phosphorus constituent and a polymeric ethylene-urea condensation product as a nitrogen-containing synergist for the intumescent fire-retardant system, as described in U.S. Pat. No. 4,772,642 to Staendeke. An example of a non-halogen fire barrier additive that can be used as the fire retardant component of the present invention or in combination with fire retardants is the Ceepree line of ceramifying fire barrier additives from Ceepree Products Ltd, Cheshire, UK.

Fire retardant component 14 can optionally comprise intumescent materials, including graphite-containing material, such as expandable graphite flake. Expandable graphite is commercially available from Nyacol Nano Technologies, Inc., Ashland, Mass., under the tradename NYACOL® NYAGRAPH and from Graftach, Cleveland, Ohio, under the tradename GRAFGUARD 220-80N.

The fire retardant component optionally can be pre-encapsulated, and preferably is encapsulated with an encapsulation material that additionally functions in support of fire retardancy. Examples of functional encapsulation material include charring agents such as starch, dextrin, sorbitol pentaerythritol, phenol-formaldehyde resins or methylol melamine encapsulation materials, or the like.

Particularly preferred fire retardant components include coated APP, which is well known as described in, e.g., U.S. Pat. No. 6,291,068 (Wang et al.), U.S. Pat. No. 5,599,626 (Fukumura et al.), and U.S. Pat. No. 5,534,291 (Fukumura et al.), the disclosures of which are incorporated herein by reference. A preferred silicone coated, APP fire retardant component for use in the present invention is commercially available from JLS Fire retardants Chemical Inc., Pomona, Calif., under the tradename JLS-APP102.

Mixtures of fire retardant components can also be used.

The fire retardant component is dispersed in the outer layer by any suitable method now apparent to the artisan, such as by premixing the fire retardant component with the polymer or a polymer precursor prior to layer formation, or mixing during formation of the outer layer such as by extrusion, coextrusion, casting or by other coating processes.

Organic support layer 16 may be any appropriate support construction having a carbon content that would be otherwise vulnerable to fire damage. Examples of such support layers include natural materials such as wood, particle board, fibers and the like. A preferred organic support layer is a polymeric material.

The configuration of the organic support materials depends on the intended ultimate use of the laminate of the present invention. In one embodiment, the polymeric support layer 16 can be constructed as a solid support to provide structure for use as building materials (e.g. trim materials, roofing materials and the like), furniture components, structural components in vehicles (such as automobiles, trains, planes, space vehicles), or any place/structure that would benefit from a very effective solution for protection from fire damage. In another embodiment, the polymeric support layer 16 is a flexible structure. In an embodiment of the invention, the polymeric support layer is in the form of a film and the laminate is capable of being wrapped around a cylinder having a 10 cm radius at 25° C. without damage to the polymeric support layer. In another embodiment of the invention, the polymeric support layer is in the form of a film and the laminate is capable of being wrapped around a cylinder having a 3 cm radius at 25° C. without damage to the polymeric support layer.

In an embodiment of the invention, the polymeric support layer is a cured polymeric film having a thickness of from about 5 to about 200 mils. In another embodiment of the invention, the polymeric support layer is a cured polymeric film having a thickness of from about 10 to about 100 mils.

Organic support layer 16 may in a preferred embodiment be prepared from any suitable polymer material. In one embodiment, the polymeric support layer comprises a polymer selected from the group consisting of ethylene polypropylene rubber, ethylene propylene diene monomer polymers, thermoplastic polyolefin, epoxy, polyurethane, polyurea, polyester, and copolymers and blends thereof. In another embodiment, the polymeric support layer comprises a polymer selected from the group consisting of ethylene polypropylene rubber, ethylene propylene diene monomer polymers, and copolymers and blends thereof.

Optionally, the polymeric support layer may additionally comprise fire retardant component in a lesser amount than present in the outer layer of the present laminate. Preferably, if the polymeric support layer comprises a fire retardant component, the fire retardant component is present at from about 0.01 to about 5% of the polymeric support layer by weight.

Optionally, the polymerizable compositions as used in the present invention (i.e. polymer based compositions that form the cured polymeric film and the polymeric support layer) can incorporate one or more additional ingredients in a manner as is understood in the art, such as, to help processing, coating, curing, and/or final cured composition properties. Such optional ingredients include, but are not limited to fillers, flow control agents, bubble control agents, free radical scavengers, ultraviolet light absorbers, fungicides, bactericides, dyes, pigments, aluminum flakes, reaction inhibitors, pot life extenders, biocides, mixtures thereof, etc.

For example, it can be highly desirable to optionally incorporate filler in polymerizable compositions, particularly in the polymeric support layer. Useful filler includes organic and/or inorganic filler. Exemplary inorganic fillers include sand, titania, clay, silica, fumed silica, combinations thereof, etc. Exemplary organic filler includes PVC, polystyrene, polypropylene, polyethylene, other olefinic fillers, combinations thereof, and the like. Preferred fillers include polyolefinic material such as polyethylene beads and/or polypropylene beads. Polyolefinic beads are lightweight and help provide cured compositions with high chemical resistance and high abrasion.

Suitable pigments include titanium dioxide, phthalocyanine blue, carbon black, basic carbonate white lead, zinc oxide, zinc sulfide, antimony oxide, zirconium oxide, lead sulfochromate, bismuth vanadate, bismuth molybdate, combinations thereof, etc.

Outer layer 12 and polymeric support layer 16 are formed into a laminate construction in any manner appropriate to the material selection and configuration of the resulting laminate article. In an embodiment of the invention, outer layer 12 and polymeric support layer 16 are formed separately and laminated by heating one or both materials so that the materials self adhere. Alternatively, outer layer 12 and polymeric support layer 16 are formed separately and laminated by use of an intermediate adhesive. In another alternative, one of outer layer 12 and polymeric support layer 16 is first formed, and the second layer is cast onto the first layer and form in place, either with or without a tie layer to assist in adhesion of the layers together. In another alternative, outer layer 12 and polymeric support layer 16 are coextruded, either with or without a tie layer to assist in adhesion of the layers together.

The present invention in particular is beneficial because the fire-retardant laminate can be used in many environments where an enhanced retardancy to fire is desirable. In one particular embodiment, the fire retardant laminate is in a format useful for use in roofing membranes, such as described in U.S. Pat. No. 6,864,195. In a particularly preferred embodiment, the fire retardant laminate is a roofing membrane comprising an outer layer that is a cured polymeric film comprising a polymer selected from the group consisting of ethylene polypropylene rubber, ethylene propylene diene monomer polymers, thermoplastic polyolefin and copolymers and blends thereof, the outer layer having a thickness of from about 10 to about 100 mils; and an organic support layer that is a cured polymeric film comprising a polymer selected from the group consisting of ethylene polypropylene rubber, ethylene propylene diene monomer polymers, thermoplastic polyolefin and copolymers and blends thereof, the organic support layer having a thickness of from about 10 to about 100 mils.

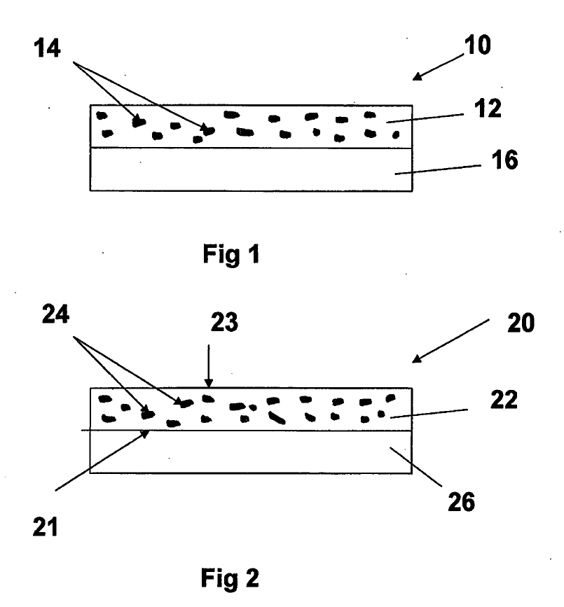

FIG. 2 shows another embodiment of the present invention, wherein a two layer fire retardant laminate 20 is provided comprising a cured polymeric film 22 having a first major surface 21 and a second major surface 23, the film 22 comprising a non-halogenated fire retardant component 24, the fire retardant component being from greater than 55% to about 95% of the polymeric film by weight. A layer of pressure sensitive adhesive 26 is coated on the first major surface 21 of the polymeric film. Preferably, pressure sensitive adhesive 26 is a continuous coating of adhesive, but alternatively may be provided as an intermittent coating. Pressure sensitive adhesives are commercially available and may be applied using conventional adhesive coating techniques.

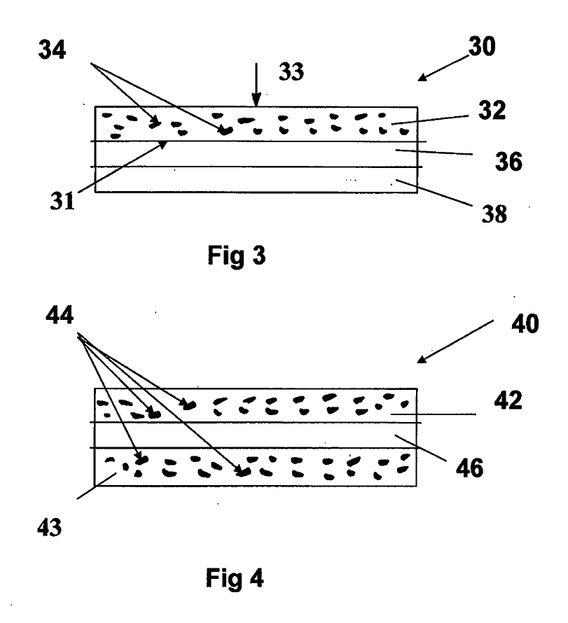

FIG. 3 shows another embodiment of the present invention, wherein a two layer fire retardant laminate 30 is provided comprising a cured polymeric film 32 having a first major surface 31 and a second major surface 33, the film 32 comprising a non-halogenated fire retardant component 34, the fire retardant component being from greater than 55% to about 95% of the polymeric film by weight. A layer of pressure sensitive adhesive 36 is coated on the first major surface 31 of the polymeric film. Release liner 38 is removably adhered to the layer of pressure sensitive adhesive 36. Release liner 38 is any material that can be removably adhered to the pressure sensitive adhesive, and are well known to artisans in the adhesive art. Examples of release liners include silicone coated papers, low surface energy plastic films, and the like.

FIG. 4 is another embodiment of the present invention, wherein fire retardant laminate 40 comprises two outer layers 42 and 43 that comprise the same or different cured polymeric films comprising a non-halogenated fire retardant component 44 dispersed therein. Outer layers 42 and 43 enclose organic support layer 46. The material selections for the outer layers, non-halogenated fire retardant component and the organic support layer may be as described above in other embodiments. It is believed that this three layered embodiment provides yet superior fire protection properties, because the organic support layer is protected from both sides from fire. This embodiment is particularly advantageous in applications such as roofing membranes, where the roof is primarily to be protected from fire damage from the outside of the roof, such as from floating embers from nearby fires, but also to inhibit the progress of a fire originating from inside the building.

As an additional benefit, the system of the present invention may be formulated and configured to provide substantial waterproofing benefits, as well as fire retardancy benefits. Thus, coating compositions of the present invention provide exceptional benefit for providing fireproofing and waterproofing for use in areas prone to natural disasters.

Because the fire-retardant laminate can comprise colorants, the resulting coating can be provided in virtually any desired color, which provides benefit from an aesthetic point of view.

The various fire retardant laminates as described herein may suitably be applied to any substrate that would benefit from fire protection. Such substrates include free standing articles, such as furniture and the like; components of vehicle systems, such as components of automobiles, trains, planes, spacecraft, and the like; building materials such as prefabricated walls, flooring, and other building construction components including support beams, trusses, framework, sashes, doors, window frames and the like; and assembled constructions such as building roofs, walls, floors, ceilings and the like.

Laminates may be applied to various structures by mechanical fasteners, adhesives such as hot melt adhesives and pressure sensitive adhesives, or any other suitable application system.

The fire-retardant laminate of the present invention exhibits exceptional fire protection properties. In evaluation, a torch is directed to a sample that has been provided with a fire-retardant laminate. The laminate itself may be partially destroyed under this test, but provides excellent protection of the underlying substrate.

### EXAMPLES

Representative embodiments of the present invention will now be described with reference to the following examples that illustrate the principles and practice of the present invention.

### Example # 1

| Raw material | % by wt. |
|---|---|
| PC-260 | 30.00 |
| CR-880(TiO2) | 10.00 |
| Tinuvin 292 | 0.40 |
| APP-101/FR CROS C30 | 60.00 |

PC-260 is a curable two component coating which consists of a NCO terminated first component and an amine/hydroxyl terminated second component. Polycoat Product, Santa Fe Springs, CA 90670
CR-880 (TiO2) - Dupont Chemicals, Wilmington, DE 19898
Tinuvin 292 is a liquid hindered-amine light stabilizer (HALS) available from Ciba Specialty Chemical s Corp., Tarrytown, NY 10591
APP-101 is an Ammonium Polyphosphate flame retardant available from JLS Chemicals, Pomona, CA 91768
FR CROS C30 is a flame retardant available from Buddenheim Iberica, Spain

Films having a thickness of 20 mil and 30 mil were prepared and cured according to the following conditions
Curing Condition:
For Example #1
1. Grind titanium in NCO terminated one component of PC-260
2. Add light stabilizer, then disperse APP 101.
3. Allow the sample to cool down to 80-95 F, then add amine/hydroxyl terminated component of PC 260 and spread the material to make a thin sheet of 10 and 20 mil.
4. Cure the sheet for a day and then laminate the cured sheet to a 75 mil thick EPDM black sheet from Carlisle Companies Incorporated, Charlotte N.C. using cyanoacrylate adhesive.

Physical Properties of Example # 1

| | |
|---|---|
| Tensile Strength (Psi) | 553.00 |
| % Elongation | 8.00 |
| Hardness (Shore A) | 90.00 |

| | Example #2 | Example #3 |
|---|---|---|
| Raw material | % by wt. | % by wt. |
| PU melathane 66 | — | 27.00 |
| EP RUBBER (Vistalon 404) | 27.81 | — |
| CR-880(TiO2) | 9.91 | 9.91 |
| Tinuvin 292 | 0.40 | 0.39 |
| APP-101/FR CROS C30 | 59.48 | 59.50 |
| Color (Ryvac Blue 312) | 0.20 | 0.20 |
| VC-60P (peroxide) | 1.40 | 3.00 |
| Carbowax 3350 | 0.79 | — |

Note:
EP RUBBER (Vistalon 404) is an EP rubber available from Exxon-Mobil, TX
PU melathane 66 from TSE Industries, Florida
CR-880 (TiO2) - is available Dupont Chemicals, Wilmington, DE 19898
Tinuvin 292 - is a liquid hindered-amine light stabilizer (HALS) available from Ciba Specialty Chemical s Corp., Tarrytown, NY 10591
APP-101 is an Ammonium Polyphosphate flame retardant available from JLS Chemicals, Pomona, CA 91768
FR CROS C30 is a fire retardant from Buddenheim Iberica, Spain
Ryvac Blue 312 - Ryvac, Inc, Anaheim, CA 92805
VC-60P (peroxide)
Carbowax 3350

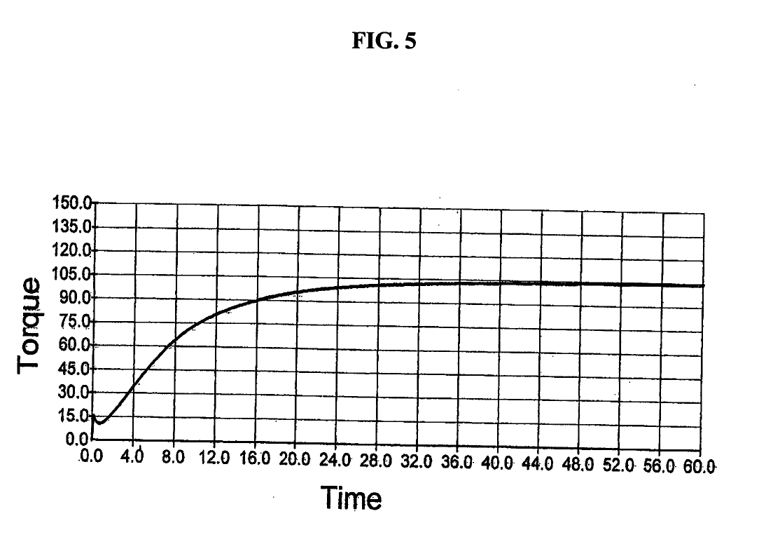

Films having a thickness of 20 mil and 30 mil were prepared and cured according to the following conditions
Curing Condition:
For Example #2
Autoclave cure for 180 minutes @ 330 F
The curing characteristic for the film of Example 2 is shown in FIG. 5, which shown evaluation of cure of the film in a torque testing apparatus is accordance with ASTM D 2084. The graph shows resistance to torque measured against time in minutes. As can be seen from this Figure, the film reaches a steady state of resistance to torque, which indicates curing of the film.
The film is laminated to a 75 mil thick EPDM black sheet from Carlisle Companies Incorporated, Charlotte N.C. using cyanoacrylate adhesive.

Physical Properties of Example #2 & #3

| | Example #2 | Example #3 |
|---|---|---|
| Tensile Strength (Psi) | 160.00 | 727.00 |
| % Elongation | 293.00 | 195.00 |
| Hardness (Shore A) | 80.00 | 98.00 |

Testing of the Samples

The samples were tested using Propane Torch (Bernzomatic TS 4000, Bernzomatic propane gas cylinder TX 9, both made by Newell Rubbermaid, Medina N.Y. 14103). The samples were positioned at a 5:12 pitch and distance between the sample and nozzle of the torch was kept at 3 inches. The sample were burnt until the EPDM sheet catches fire.

| | Each sample burned by propane torch at inclination |
|---|---|
| System | of 45 degrees |
| EPDM black | Film starts burning vigorously after 30 sec of starting the |
| sheet (from | test. Lots of smoke generated |
| Carlisle) | |
| Example # 1 | Film starts developing charred structure after 1 minute. |
| | The EPDM rubber started melting after 17 minutes. The |
| | total time for the test - 17 minutes. |
| Example # 2 | Film starts developing charred structure after 1 minutes. |
| | The EPDM rubber started melting after 17 minutes and |
| | 30 seconds.. The total time for the test - 17 minutes 30 |
| | second. |
| Example # 3 | Film starts developing charred structure after 1 minutes. |
| | The EPDM rubber started melting after 19 minutes and |
| | 30 seconds.. The total time for the test - 19 minutes 30 |
| | second. |

Conclusion:

A significant improvement in fire resistance of EPDM sheets is observed when the EPDM sheet is laminated with Example #1, Example #2 and Example #3 fire retardant layers as compared to non-coated EPDM sheet.

All patents, patent applications (including provisional applications), and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A roofing membrane that is a laminate comprising:
a) an outer layer of a cured polymeric film comprising a non-halogenated fire retardant component, the fire retardant component being from greater than about 55% to about 95% of the outer layer by weight; and
b) a polymeric film underlayer.

2. The roofing membrane of claim 1, wherein the cured polymeric film of the outer layer comprises a polymer selected from the group consisting of ethylene polypropylene rubber, ethylene propylene diene monomer polymers, thermoplastic polyolefin and copolymers and blends thereof.

3. The roofing membrane of claim 1, wherein the cured polymeric film of the underlayer comprises a polymer selected from the group consisting of ethylene polypropylene rubber, ethylene propylene diene monomer polymers, thermoplastic polyolefin and copolymers and blends thereof.

4. The roofing membrane of claim 1, wherein the outer layer has a thickness of from about 0.5 mils to about 120 mils.

5. The roofing membrane of claim 1, wherein the outer layer has a thickness of from about 10 mils to about 30 mils.

6. The roofing membrane of claim 1, wherein the fire retardant component is from about 60% to about 90% of the outer layer by weight.

7. The roofing membrane of claim 1, wherein the roofing membrane is free of antimony.

8. The roofing membrane of claim 1, wherein the fire retardant component is a phosphate-based fire retardant component.

9. The roofing membrane of claim 1, wherein the fire retardant component comprises a polyphosphate.

10. The roofing membrane of claim 1, wherein the polyphosphate comprises ammonium polyphosphate.

11. A method for protecting a roof surface substrate from fire damage, comprising
a) providing the roofing membrane of claim 1, and
b) applying the roofing membrane to a roof surface substrate with the polymeric film underlayer being in contact with the roof surface substrate.

12. A method for protecting a substrate from fire damage, comprising
a) providing a fire retardant laminate, comprising:
i) an outer layer of a cured polymeric film comprising a non-halogenated fire retardant component, the fire retardant component being from greater than about 55% to about 95% of the outer layer by weight; and
ii) an organic support layer to which the outer layer is laminated; and
b) applying the fire retardant laminate to a substrate with the organic support layer being in contact with the substrate.

13. The method of claim 13, wherein the organic support layer is a polymeric material in the form of a flexible structure.

14. The method of claim 12, wherein the organic support layer is a polymeric film having a thickness of from about 5 to about 200 mils.

15. The method of claim 13, wherein the polymeric material and the outer layer independently comprises a polymer selected from the group consisting of ethylene polypropylene rubber, ethylene propylene diene monomer polymers, thermoplastic polyolefin, and copolymers and blends thereof.

16. The method of claim 12, wherein the outer layer has a thickness of from about 0.5 mils to about 120 mils.

17. A fire retardant laminate for application to a substrate, comprising:
a) a polymeric film having a first and a second major surface, the film comprising a non-halogenated fire retardant component, the fire retardant component being from greater than 55% to about 95% of the polymeric film by weight;
b) a layer of pressure sensitive adhesive coated on the first major surface of the polymeric film; and
c) a release liner removably adhered to the layer of pressure sensitive adhesive.

18. A fire retardant laminate having at least three layers comprising:
a) a first outer layer of a polymeric film comprising a non-halogenated fire retardant component, the fire retardant component being from greater than about 55% to about 95% of the outer layer by weight;
b) an intermediate organic support layer; and
c) a second outer layer of a polymeric film comprising a non-halogenated fire retardant component, the fire retardant component being from greater than about 55% to about 95% of the outer layer by weight.

19. The laminate of claim 18, wherein each of the first and second outer layers independently comprises a polymer selected from the group consisting of ethylene polypropylene rubber, ethylene propylene diene monomer polymers, thermoplastic polyolefin, epoxy, polyurethane, polyurea, polyester, and copolymers and blends thereof.

20. A method for protecting a substrate from fire damage, comprising
a) providing a fire retardant laminate of claim 18; and
b) applying the fire retardant laminate to a substrate to be protected from fire damage.
